(19) United States
(12) Patent Application Publication
(10) Pub. No.: US 2016/0030778 A1
(43) Pub. Date: Feb. 4, 2016

(54) RESPIRATOR MASK COMPRISING A SLIDING SEAT DEVICE

(71) Applicant: MOLDEX-METRIC, INC., CULVER CITY, CA (US)

(72) Inventors: TORBEN SKOV, PLIEZHAUSEN (DE); FRANK KERN, PLIEZHAUSEN (DE)

(73) Assignee: MOLDEX-METRIC, INC.

(21) Appl. No.: 14/613,712

(22) Filed: Feb. 4, 2015

(30) Foreign Application Priority Data
Feb. 6, 2014 (DE) 102014001940.3

(51) Int. Cl. A62B 23/02; A62B 18/02; A62B 18/10

(52) U.S. Cl. CPC A62B 23/025; A62B 18/10; A62B 18/02

(57) ABSTRACT

The invention relates to a respirator mask comprising a mask. body, comprising at least one exhalation valve and at least one inhalation valve. At least one filter module assigned to the inhalation valve and comprising a sliding seat device for detachably fastening the filter module to the mask body. The respirator mask encompasses an accommodating recess for accommodating at least partially the filter module. The accommodating recess is embodied in a substantially cup shaped manner and, at two opposite side walls, in each case to encompass a guide web. The guide web protrudes into the accommodating recess, wherein the guide webs run parallel to one another and, at two opposite side wall sections, the filter module in each case encompasses at least one guide groove of the sliding seat device for accommodating one of the guide webs in each ease.

This Application is based on and claims the benefit of priority from the German Patent Application No. 102014001940.3 filed on Feb. 6, 2014, the contents of which are incorporated by reference.

The invention relates to a respirator mask, comprising a mask body, comprising at least one exhalation valve and comprising at least one inhalation valve, comprising at least one filter module assigned to the inhalation valve and comprising a sliding seat device for detachably fastening the filter module to the mask body, said respirator mask encompasses an accommodating recess for at least partially accommodating the filter module.

### BACKGROUND ART

Respirator masks of the above-mentioned type are known from the state of the art. They are used to protect a user from air contaminants when breathing. By means of a mask body, which can be arranged over mouth and nose of the user, a closed head space, which is separated from the environment, is formed for the user. A gas or air exchange, respectively, can then take place between the user and the environment through the mask body with the help of at least one exhalation valve and at least one inhalation valve, both of which are arranged at the mask body. To ensure the purity of the inhaled air for the user, a filter module, through which the inhaled air must flow before it reaches the inhalation valve, is in each case assigned to the inhalation valve or to each inhalation valve, respectively. To be able to use the respirator mask for a long period of time, in particular also if the filter modules show signs of deterioration, it is necessary for the filter module(s) to be capable of being replaced, if necessary. Various solutions are already known relating to the replaceability of filter modules at gas masks. For example, U.S. Pat. No. 5,222,488 thus discloses a filter module, which can be screwed to the mask body. A respirator mask, in the case of which the filter module can be connected to the mask body by means of a bayonet closure, furthermore follows from U.S. Pat. No. 4,934,361. A respirator mask, which encompasses a sliding seat device for detachably holding a filter module, is already known from U.S. Pat. No. 4,771,771. The sliding seat device encompasses a plug-in frame, into which the filter module can be plugged or inserted, respectively. The plug-in frame forms an accommodating recess, in which the filter module is accommodated completely. The embodiment of the filter module is thereby limited to the embodiment of the plug-in frame, which forms a pocket, which is located upstream of the inhalation valve, so that it is not impossible, for example, to provide filter modules of varying sizes at the respirator mask.

### SUMMARY OF INVENTION

The invention is thus based on the task of creating a respirator mask, which provides for an easy replaceability of one or a plurality of filter modules and furthermore also for the attachment of filter modules, which are different in nature, in particular which are formed differently.

The task on which the invention is based is solved by means of a respirator mask comprising the features described herein. Due to the advantageous embodiment of the sliding seat device of the respirator mask, the form of the filter modules, which can be fastened to the respirator mask, is no longer limited to the form of a plug-in frame. Due to the fact that the means of the respirator mask according to the invention, which are necessary for the detachable fastening, only interact sectionwise with the respective filter module, so that the respective filter module is in particular accommodated in the accommodating recess only partially, it is attained that the part of the filter module outside of the accommodating recess, which is not accommodated, can be designed freely. Filter modules of varying sizes, for example comprising different filter effects, can thus be detachably fastened to the respirator mask. According to the invention, provision is made for this purpose for the accommodating recess to be embodied in a substantially cup-shaped manner and, at two opposite side walls, in each case to encompass at least one guide web, which protrudes into the accommodating recess, wherein the guide webs run parallel to one another and, at two opposite side wall sections, the filter module in each case to encompass at least one guide groove of the sliding seat device for accommodating one of the guide webs respectively. Due to the cup-shaped embodiment of the accommodating recess, the latter encompasses an at least substantially circumferential side wall as well as a bottom, at which the side wall originates. Due to the embodiment of the sliding seat device with the guide webs and the guide grooves, it is no longer possible to insert the filter module directly into the accommodating recess. Instead, it is required for the filter module to be slid laterally into the accommodating recess according to the orientation of the guide webs and guide grooves. While the design of the contour of the filter module on the rear side, which faces the accommodating recess, is limited by the guide elements and guide grooves, the front side, which protrudes beyond the mask body, can be designed freely. It is thus possible to attach filter modules of varying sizes to the mask body in a simple manner.

According to an advantageous further development of the invention, provision is made for the guide webs and/or the guide grooves to at least section wise run towards a bottom of the accommodating recess in an declined manner, so that the filter module is moved in the direction of the bottom of the accommodating recess in response to being slid in, wherein the inlet valve is arranged in the bottom of the accommodating recess. Provision is thus made for the filter module not to be moved parallel, but at an angle towards the bottom in response to being slid in. The decline is thereby preferably chosen such that the filter module is pressed against the bottom of the accommodating recess, so as to obtain a tight connection between filter module and mask body. Apart from the tight connection, a holding force is furthermore also provided, which holds the filter module in a frictionally engaged manner in a use position, when the filter module was slid into the accommodating recess to an appropriate extent. In a particularly preferred manner, the filter module bottom is thereby embodied so as to be elastic at least partially, so as to ensure a pretensioning of the filter module in the accommodating recess, which serves to lock the filter module in place.

Provision is preferably further made for the filter module to encompass a filter module bottom, which is assigned to the bottom of the accommodating recess and which, in the use position of the filter module, is arranged at least substantially at a distance to the bottom, so as to form an air chamber. In the use position of the filter module, an air chamber is thus located between the filter module and the bottom of the accommodating recess. For example, this air chamber serves the purpose of collecting the air, which entered through the filter, and to supply it to the inlet valve. Advantageously, the filter module bottom encompasses a plurality of flow-through openings, through which the air can reach from the filter module into the air chamber. This makes it possible that the counter pressure is not uncomfortably high when inhaling through the filter module

According to an advantageous further development of the invention, provision is made for the bottom of the accommodating recess to encompass a curved surface. The mask body thus optimally adapts to the face of the user. In addition, the curved surface has the advantage that the filter module is at least partially automatically pressed against the bottom of the accommodating recess in response to being slid in. In particular, this makes it possible to reach an even stressing of the bottom and of the filter module when they are pressed onto one another with only a slight frictional contact between filter module and accommodating recess in spite of a straight course of the guide elements. The filter module can thus be moved into the use position securely without a large exertion of force and in particular also without wear.

Preferably, at least one sealing web extends in a frame-like manner around the inlet valve on the bottom of the accommodating recess and/or at the filter module bottom, so as to laterally close the air chamber, so that the purity of the filtered air is preserved. According to a further embodiment, provision is made additionally or in the alternative for the outer contour of the filter module and the contour of the accommodating recess to correspond to one another such that a lateral seal is formed between the side walls and the side wall sections. However, the sealing web has the advantage that it is tightened between the filter module and the mask body when moving the filter module into the use position, whereby a particularly secure sealing is ensured. In a particularly preferred manner, the sealing web can be deformed elastically at least partially so as to provide for the above-mentioned spring force and so as to reach a particularly high sealing effect.

The sealing web thereby preferably extends parallel to the outer contour of the respective accommodating recess. In the alternative, the sealing web can also encompass a form, which is independent from the outer contour or which differs therefrom, respectively. For example, the sealing web can extend around the inlet valve in a circular ring-shaped manner. Provision can thereby in particular be made for the sealing web to always be arranged at a distance to the side walls of the respective accommodating recess. It is also possible for the ring shape of the sealing web to not be embodied so as to be circular, but, for example, polygonal, for example square or rectangular or also in a star-shaped manner.

Provision is preferably made only in the area of the air chamber for the filter module bottom to encompass a plurality of flow-through openings, through which air, which is filtered by a filter element of the filter module, is guided into the air chamber. As already mentioned above, the plurality of flow-through openings increases the comfort when using the respirator mask. By limiting the flow-through openings to the area of the air chamber, it is ensured that the filter module is used optimally.

Provision is further preferably made for the accommodating recess to encompass a contour, which is defined by the side walls and which differs from a circle. The side walls thereby serve in particular also for guiding the filter module when being slid in, so that, on the one hand, a reliable placement of the filter module all the way to the use position is ensured and, on the other hand, that a high-quality impression is created in response to the use or in response to the replacement of the filter module, respectively.

Provision is further preferably made for the outer contour of the filter module to correspond to the contour of the accommodating recess, at least on a rear side, which faces the mask body. As already mentioned above, an additional sealing effect is attained between filter module and mask body by means of the side wall sections and the side walls. In addition, the respirator mask thus attains a high-quality optical impression.

According to a preferred further development of the invention, provision is furthermore made for the sliding seat device to encompass a latching means for locking the filter module in place in its use position. In addition or as an alternative to the sealing web, which is provided if applicable, and which provides for a spring force, the latching means secure the filter module in its use position. Due to the embodiment as latching means, no switches or levers must be operated for detaching the filter module, which facilitates the replacement of the filter module.

Provision is made in a particularly preferred manner for the latching means to encompass at least one latch protrusion, which is embodied at one of the guide elements, and a corresponding latch recess, which is embodied at one of the guide grooves, and/or a latch recess, which is embodied at at least one of the guide elements and a corresponding latch protrusion, which is embodied at one of the guide grooves. In the use position, latch protrusion and latch recess interact for locking the filter module in place. In particular, the latching means act such that a sliding movement along the guide elements is prevented. The latch protrusion thus protrudes from the guide element vertically to the sliding direction or protrudes into the guide groove, so as to prevent a shifting of the filter module. The latch protrusion reaches out of the latch recess only if a sufficient force is applied and thus allows for a further sliding of the filter module. Provision is made in a particularly preferred manner for this purpose for the latch protrusion to be embodied so as to be elastically deformable at least sectionwise, so that the latching means have a high durability and make it possible to replace filter modules several times.

According to a preferred further development of the invention, provision is made for the mask body to be embodied in multiple parts, comprising a mask base body and comprising at least one shell element, which forms the respective accommodating recess, wherein the shell element preferably encompasses a higher stiffness than the mask base body. Due to the multi-part embodiment, the production of the mask body is simplified. In addition, the multi-part embodiment makes it possible for the mask base body and the shell element to encompass different characteristics in particular with reference to their flexibility. Due to the preferred embodiment according to which the mask base body encompasses a higher flexibility than the shell element, it is ensured that the mask base body adapts comfortably to the facial shape of the user on the one hand and that the shell element ensures a sufficiently high stiffness for securely and tightly connecting the filter module to the mask body.

### BRIEF DESCRIPTION OF THE DRAWINGS

The invention will be explained in more detail below by means of an exemplary embodiment.

FIG. 1 shows a respirator mask in a perspective illustration,

FIG. 2 shows the respirator mask in an exploded illustration,

FIG. 3 shows a filter module of the respirator mask in a perspective illustration and

FIG. 4 shows the respirator mask without filter module in a side view.

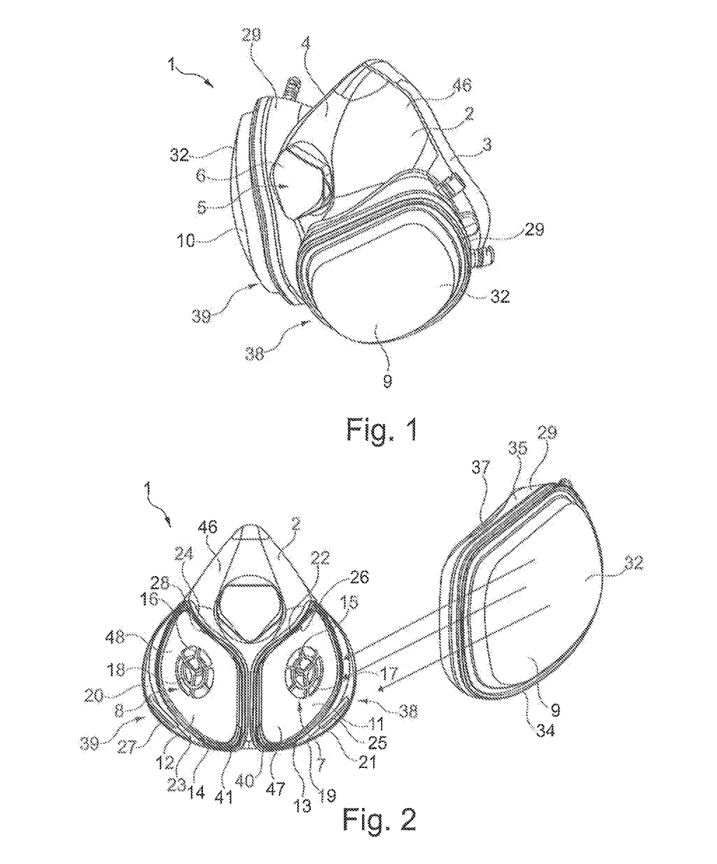

In a perspective illustration, FIG. 1 shows a respirator mask 1, which encompasses a mask body 2, which is embodied to separate the nose and the mouth of a user from the environment. For this purpose, the mask body 2 encompasses a flexible sealing lip 3, facing the user. Said sealing lip 3 adapts to the facial shape of the user in a gas-tight manner, when the respirator mask 1 is pressed against the face of the user. For example, fastening straps, which engage behind the head of the user and which are fastened to the mask body 2, can be used for this purpose. In the center, the mask body 2 encompasses a curvature 4, which is to be assigned to the nose of the user and which supports an exhalation valve 5, which, in the exemplary embodiment shown in FIG. 1, is covered by a test valve 6, which can be operated, for testing the gas-tightness of the respirator mask 1. The exhalation valve 5 reaches through the mask body 2 and allows air to escape to the outside from the interior of the respirator mask 1, while it closes in opposite flow direction, so that the user cannot inhale unfiltered air from the environment through the exhalation valve 5.

For inhalation, provision is made for two inhalation valves 7, 8, which are arranged below the curvature 4 and on both sides of the curvature 4, as can be seen from FIG. 2, which shows the respirator mask 1 in a top view. A filter module 9, 10, which can be arranged on the outside of the respirator mask 1, as is shown in FIG. 1, are in each case assigned to the inhalation valves 7 and 8.

The inlet valves 7, 8 are each arranged in a bottom 11, 12 of a respective accommodating recess 13, 14, respectively. For this purpose, an opening is in each case embodied in the respective bottom 11, 12. A lattice structure 15, 16, which, in its center, supports a flexible filter element on the inside of the mask body 2, in each case extends in the respective opening. As usual, the flexible filter elements 17, 18 are thereby embodied in a circular disk-shaped manner and act as a flutter valve, so as to become detached from the lattice structure 15 or 16, respectively, when the user inhales, so as to unblock the respective opening 13 or 14, respectively, and so as to place themselves against the lattice structure 15, 16 when the user exhales, so as to close the respective opening 13, 14. In the instant case, the respective bottom 11, 12 of the accommodating recesses 13, 14 is embodied so as to be curved in a plurality of directions, so that an advantageous wearing comfort as well a design of the respirator mask 1, which appears to he optically advantageous, is ensured.

The accommodating recesses 13, 14 are in each case limited by an edge 19, 20, which is substantially continuous and which extends in a contour, which differs from a circle, around the respective inhalation valve 7, 8 and at a distance thereto. The contour thereby substantially corresponds to that of a rectangle comprising rounded corners, so that each of the accommodating recesses 13, 14 in each case encompasses two side walls 21 and 22 or 23 and 24 respectively, which are located opposite one another and which run at least substantially parallel to one another. A guide web 25, 26, 27 or 28, respectively, which protrudes into the respective accommodating recess 13, 14, is in each case embodied at each of the side walls 21 to 24. The guide webs 25 to 28 are thereby arranged at a distance to the respective bottom 11 or 12, respectively, at the corresponding side wall 21 to 24 and run in particular at a decline to the respective bottom 11, 12. The guide webs 25 and 26 or 27 and 28, respectively, which are arranged at side walls 21, 22 or 23, 24, respectively, which are located opposite one another, thereby run parallel to one another and are embodied in particular so as to be mirror-inverted to one another.

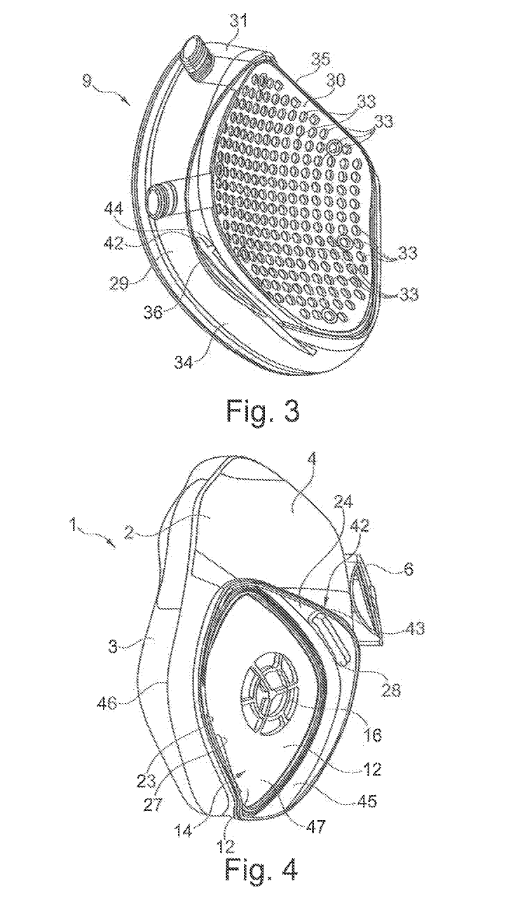

FIG. 3 shows the filter module 9 of the respirator mask 1 in a perspective illustration with view onto the rear side, which faces the mask body 2 when in use. The filter module 10 is embodied accordingly, so that the descriptions provided for the filter module 9 also apply to the filter module 10.

The filter module 9 encompasses a filter module housing 29, which is embodied in a substantially cup-shaped manner, comprising a filter module bottom 30 and a circumferential side wall 31, which originates at the filter module bottom 30. A filter element 32, which can be embodied in a common manner, is inserted into the filter module housing 29. The filter module bottom 30 encompasses a plurality of flow-through openings 33, only a few of which are provided with reference numerals herein for the sake of clarity. The filter element 32 extends across all of the flow-through openings 33, so that only air, which is filtered through the filter element 32, can flow out of the flow-through openings 33.

The filter module housing 29 encompasses an outer contour, which substantially corresponds to the contour of the edge 19 of the accommodating recess 13, so that the filter module housing 29 can be inserted into the accommodating recess 13 at least in a substantially accurately fitting manner. Two side wall sections 34, 35 of the filter module housing 29, which are located opposite one another, thereby in each case encompass a guide groove 36 and 37, which run parallel to one another. Together, the guide grooves 36, 37 and the guide webs 25, 26 in each case form a sliding seat device 38 for detachably fastening the filter module 9 to the mask body 2. Accordingly, the guide elements 27, 28 are embodied to form a sliding seat device 39 with corresponding guide grooves of the filter module 10.

The guide webs 25 to 28 and the corresponding guide grooves 36, 37 are embodied such that the respective guide module 9 can be slid laterally into the accommodating recess 13, as is suggested in FIG. 1 by means of arrows, substantially parallel to the respective bottom 11, 12. Due to the curvature of the bottom and due to the declined orientation of the guide webs 25, 26 or 27, 28, respectively, it is attained that, when inserting the filter module 9 or 10, respectively, the latter is also moved in the direction of the bottom 11, 12. In the instant case, a circumferential sealing web 40, 41, against which the filter module housing 29 of the respective filter module 9, 10 is pressed when being slid into the respective accommodating recess 13, 14, extends in the respective accommodating recess 13, 14, parallel to the respective edge 19, 20 on the bottom 11 or 12, respectively, so that a gas-tight connection is ensured between the filter modules 9, 10 and the mask body 2. An air chamber, which. is laterally limited by the respective sealing web 40, 41, is then formed between the filter module bottom 30 and the bottom 11 or 12, respectively. This makes it possible that only air, which is filtered through the respective filter module 9, 10 reaches to the respective inhalation valve 7, 8.

The guide webs 25 to 28 are accordingly embodied such that they are guided in the guide grooves 36, 37 of the respective filter module 9, 10 substantially without play, so as to ensure that said filter module rests securely against the mask body 2. Due to the advantageous elastically deformable embodiment of the sealing webs 40, 41, a spring force, which exerts a pretension on the respective filter module 9, 10 in its use position, thus when in the state of being slid into the respective accommodating recess 13, 14, is furthermore provided when sliding in the respective filter module 9, 10. The respective filter module 9, 10 is thus securely held in the respective accommodating recess 13, 14 in a frictionally engaged manner.

Advantageously, as illustrated in the instant exemplary embodiment, provision is additionally made for latching means 42, which serve the purpose of holding the respective filter module 9, 10 in its use position so as to be locked in place. According to the instant exemplary embodiment, provision is thereby made for the guide webs 25 to 28 to in each case encompass a latch protrusion 43, as it can best be seen in FIG. 4, which interacts with a latch recess 44, which is provided at the respective guide groove 36, 37, so as to form a lock. According to the instant exemplary embodiment, the latch protrusion 43 is thereby embodied such that it protrudes in the direction of the bottom 11, 12 of the respective accommodating recess 13, 14, from the respective guide web 25 to 28. Accordingly, the latch recess 44 is oriented at the respective guide groove 36, 37. The latching means 42 thus allow for positively locking the respective filter module 9, 10 in place in the use position. By applying a sufficient force, the latch connection is declamped and the respective filter module 9, 10 can be slid out of the respective accommodating recess 13, 14 and can be replaced, for example.

As an alternative to the illustrated exemplary embodiment, it goes without saying that it is also possible for the latch protrusions to be embodied at the respective guide web 25 to 28 so as to protrude laterally, thus in the direction of the accommodating recesses 13, 14, or away from the respective bottom 11, 12 to the outside. It is also possible not to provide the latching means in the area of the guide webs 25 to 28, but directly at the side wall sections 34, 35 of the filter module housing 29 of the respective filter module 9, 10 or at a distance to the guide webs 25 to 28, respectively, at the respective side walls 21, 22 or 23, 24, respectively.

As can best be seen from FIG. 4, the accommodating recesses 13, 14 are embodied such that they encompass a third side wall 45, which connects the side walls 21, 22 or 23, 24, respectively, which are located opposite one another, and to which the respective filter module 9, 10 can be maximally slid into the respective accommodating recess 13, 14. The section of the accommodating recess 13, 14, which is located opposite the side wall 45, is thereby preferably embodied without or with only a low side wall, so as to be able to slide the respective filter module 9, 10 at that location in a simple manner.

Due to the fact that the sliding seat devices 38, 39 are limited to a limited section of the filter module housing 29 of the respective filter module 9, 10, the area of the respective filter module 9, 10, which protrudes from the mask body 2 outside of the accommodating recess 13, 14, can be designed individually, whereby an available filter module, for example, can be replaced with a filter module of a different size or with a different filter effect in a simple manner. Preferably, provision is made for this purpose for a respirator mask system, which provides for a base body comprising a plurality of different filter modules, which can be fastened to the mask body in the manner described above.

Advantageously, the mask body 2 of the respirator mask 1 is embodied in one piece with the accommodating recesses 13, 14. The sealing webs 40, 41 can also be embodied in once piece with the mask body 2. In the alternative, the sealing webs 40, 41 are made of a different material and are injected onto the respective bottom 11, 12 subsequently.

According to the instant exemplary embodiment, provision is made for the mask body 2 to be embodied in multiple parts, wherein it encompasses a mask base body 46 and two shell elements 47, 48, which in each case form an accommodating recess 13, 14. The shell elements thereby encompass a higher stiffness than the mask base body 46, whereby the mask base body 46 adapts comfortably to the facial shape of the user on the one hand and a sufficiently high stiffness for securely and tightly connecting the respective filter module 9, 10 to the mask body 2 is ensured by means of the shell elements 47, 48.

We claim:

1. A respirator mask comprising a mask body, comprising at least one exhalation. valve and comprising at least one inhalation valve comprising at least one filter module assigned to the inhalation valve and comprising a sliding seat device for detachably fastening the filter module to the mask body, said respirator mask encompasses an accommodating recess for at least partially accommodating the filter module, wherein the accommodating recess is embodied in a substantially cup-shaped manner and, at two opposite side walls, in each case encompasses at least one guide web, which protrudes into the accommodating recess, wherein the guide webs run parallel to one another and, at two opposite side wall sections, the filter module in each case encompasses at least one guide groove of the sliding seat device for accommodating one of the guide webs in each case.

2. The respirator mask according to claim 1, wherein the guide webs and/or the guide grooves at least sectionwise run towards a bottom of the accommodating recess in an declined manner, so that the filter module is moved in the direction of the bottom of the accommodating recess in response to being slid in, wherein, the inlet valve is arranged in the bottom of the accommodating recess.

3. The respirator mask according to claim 2, wherein the filter module encompasses a filter module bottom, which is assigned to the bottom of the accommodating recess and which, in the use position of the filter module, is arranged at least substantially at a distance to the bottom, so as to form an air chamber.

4. The respirator mask according to claim 2, wherein the bottom. of the accommodating recess encompasses a curved surface.

5. The respirator mask according to claim 3, wherein at least one sealing web extends in a frame-like manner around the inlet valve on the bottom of the accommodating recess and/or at the filter module bottom, so as to laterally close the air chamber.

6. The respirator mask according to claim 3, wherein, only in the area of the air chamber, the filter module bottom encompasses a plurality of flow-through openings, through which air, which is filtered by a filter element of the filter module, is guided into the air chamber.

7. The respirator mask according to claim 1, wherein the accommodating recess encompasses a contour, which is defined by the side walls and which differs from a circle.

8. The respirator mask according to claim 1, wherein, at least at its rear side, which faces the mask body, the outer contour of the filter module corresponds to the contour of the accommodating recess.

9. The respirator mask according to claim 1, wherein the sliding seat device encompasses latching means for locking the filter module in place in its use position at the mask body.

10. The respirator mask according to claim 1, wherein the latching means encompass at least one latch protrusion, which is embodied at one of the guide webs, and a corresponding latch recess, which is embodied at one of the guide grooves, and/or a latch recess, which is embodied at at least one of the guide webs and a corresponding latch protrusion, which is embodied at one of the guide grooves.

11. The respirator mask according to claim 1, wherein the mask body is embodied in multiple parts, comprising a mask base body and comprising at least one shell element, which forms the respective accommodating recess.
